(19) United States
(12) Patent Application Publication
(10) Pub. No.: US 2008/0232355 A1
(43) Pub. Date: Sep. 25, 2008

(54) SESSION INITIATION PROTOCOL TRUNK GATEWAY APPARATUS

(75) Inventor: Ryo Araki, Fuchu-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/047,711

(22) Filed: Mar. 13, 2008

(30) Foreign Application Priority Data
Mar. 19, 2007 (JP) 2007-071010

(51) Int. Cl. H04L 12/66

(52) U.S. Cl. 370/352

(57) ABSTRACT

According to one embodiment, a session initiation protocol trunk gateway apparatus includes a register which registers each connection ID of the plurality of terminals registered in a registration table into a registration server on the session initiation protocol network in accordance with a prescribed registration period, a connector which connects among the plurality of terminals and the session initiation protocol network, a processor which divides the registration period into a plurality of distribution intervals in response to the number of the connection IDs and executes registration processing of the next second connection IDs by spacing of the distribution interval from a registration start of a first connection ID, and a controller which executes registration processing of the corresponding-connection IDs into the registration server in preference to the processor based on prescribed conditions in processing by the processor.

### CROSS-REFERENCE TO RELATED APPLICATIONS

This application is based upon and claims the benefit of priority from Japanese Patent Application No. 2007-071010, filed Mar. 19, 2007, the entire contents of which are incorporated herein by reference.

### BACKGROUND

1. Field

One embodiment of the present invention relates to a session initiation protocol (SIP) trunk gateway apparatus which connects among a plurality of SIP terminals equipped with communication functions specified by an SIP and an SIP network.

2. Description of the Related Art

In recent years, a network telephone system (IP telephone system) which interactively transmits and receives images and audio in real time as packet data has begun widely used. The IP telephone system may perform extension communication and external line outgoing and incoming calls among main apparatuses via the IP network as well as extension communication and external line outgoing and incoming calls for each main apparatuses to be connected to the IP network. The SIP has become widely used as its protocol in the IP telephone system.

Such a kind of system registers URIs (connection IDs) of SIP terminals for each main apparatus in a registration server on an SIP network in advance, and the registration server authenticates the SIP terminals based on the registered URIs when the SIP terminals communicate by the use of the SIP network.

Meanwhile, in the system, when registering URIs of a plurality of SIP terminals (hereinafter refereed to as SIPURIs) in the registration server on the SIP network, since the one main apparatus has a monopoly on the SIP network, the traffic on the SIP network becomes heavy and the processing load on the main apparatus in registration processing becomes heavy. This fact becomes clear as an increase in the number of SIP terminals to be covered by the main apparatus.

In conventionally, a key telephone system in which a main apparatus with extension telephone sets housed therein registers SIPURIs in an SIP server by the number of the extension telephone sets in starting the main apparatus with the extension telephone set housed therein or in changing system data has been presented (e.g., Jpn. Pat. Appln. KOKAI Publication No. 2004-363790).

However, in the foregoing systems, if the registration of all the SIPURIs into the SIP server results in failure, the registration processing is not be performed until a prescribed registration period comes then outgoing and incoming call processing may not be performed. The same situation applies when additional registration of new SIP-URIs is performed caused by a change in setting during system operation, since the registration processing will not be performed until the next registration period comes, the added SIPURIs may not be used up to that time.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a schematic diagram of an IP telephone system regarding the first embodiment of the invention;

FIG. 2 is a block diagram depicting a functional configuration of a private exchange depicted in FIG. 1;

FIG. 3 is a view depicting an example of each piece of storage contents of a registration control information table and an SIPURI table depicted in FIG. 2;

FIG. 4 is a block diagram depicting an outline of a REGISTER system by outgoing call operation during failures of all ‘SIPURI-REGISTER’ in the first embodiment;

FIG. 5 is a processing sequence view of FIG. 4; and

FIG. 6 is a schematic sequence view depicting an immediate ‘REGISTER’ (registration) processing system in newly adding SIPURI as the second embodiment of the invention.

### DETAILED DESCRIPTION

Various embodiments according to the invention will be described hereinafter with reference to the accompanying drawings. In general, according to one embodiment of the invention, a session initiation protocol trunk gateway apparatus to house a plurality of terminals equipped with communication functions mutually specified by session initiation protocol, and to connect a session initiation protocol network, comprising: a register which registers each connection ID of the plurality of terminals registered in a registration table into a registration server on the session initiation protocol network in accordance with a prescribed registration period; a connector which connects among the plurality of terminals and the session initiation protocol network, to communicate among the plurality of terminals registered by the register and the session initiation protocol network; a processor which divides the registration period into a plurality of distribution intervals in response to the number of the connection IDs and executes registration processing of the next second connection IDs by spacing of the distribution interval from a registration start of a first connection ID among the plurality of connection IDs; and a controller which executes registration processing of the corresponding-connection IDs into the registration server in preference to the processor based on prescribed conditions in processing by the processor.

### First Embodiment

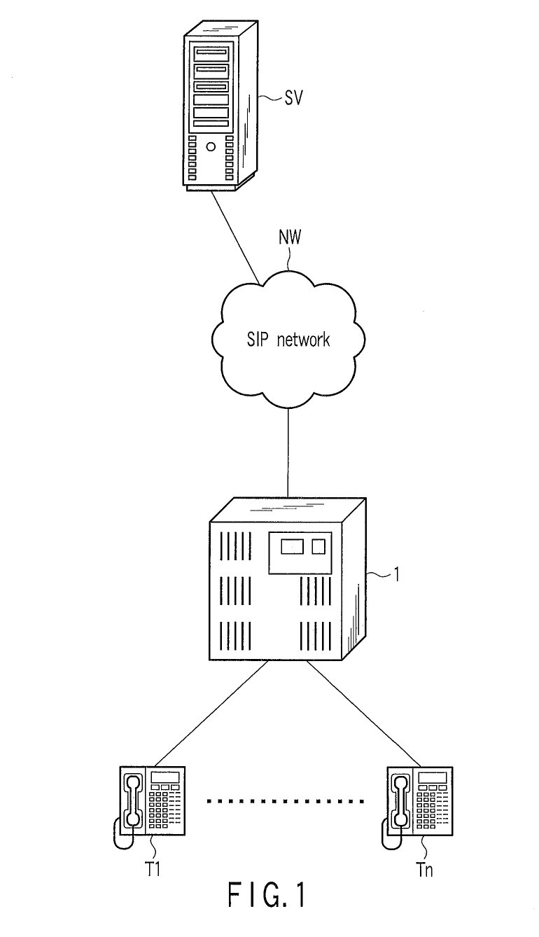

FIG. 1 shows a schematic diagram of an IP telephone system regarding the first embodiment of the invention, the numeric FIG. 1 indicates a private exchange apparatus as an SIP trunk gateway apparatus.

The exchange apparatus 1 houses a plurality of SIP terminals T1-Tn (n is a natural number). A registration server SV is connected with the exchange apparatus 1 via an SIP network NW.

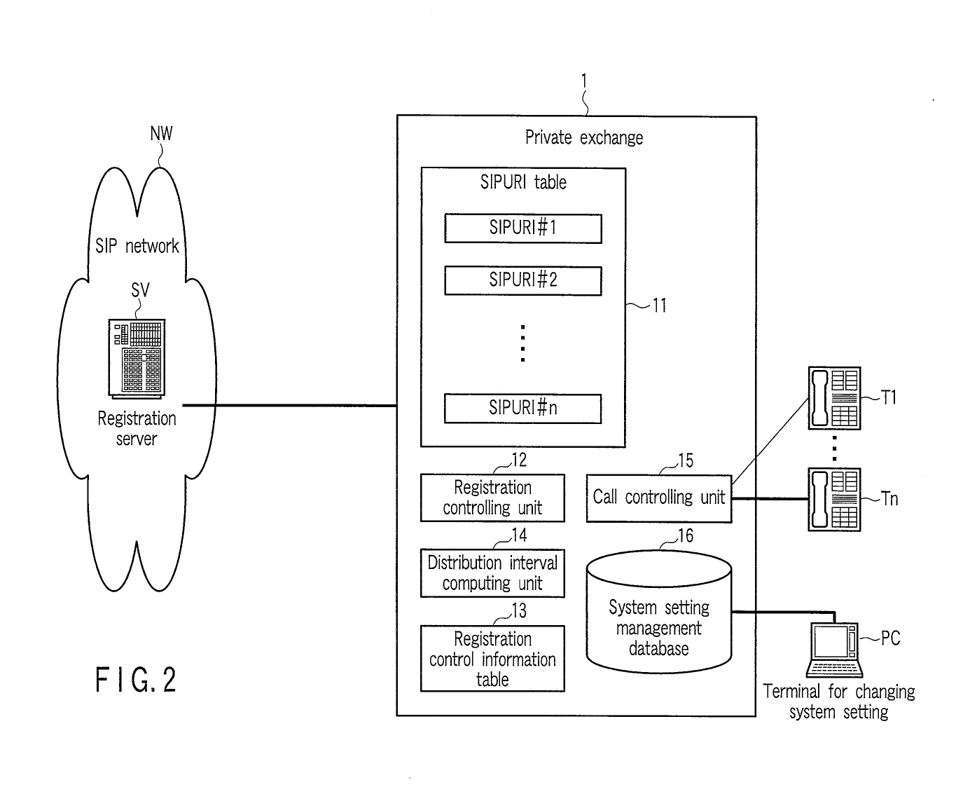

FIG. 2 shows a block diagram illustrating a functional configuration of the exchange apparatus 1.

That is, the exchange apparatus 1 includes an SIPURI table 11 which stores a plurality of SIPURIs granted from a service provider on the SIP network NW to each SIP terminal T1-Tn; a registration controlling unit 12 which registers the SIPURIs in the registration server SV on the SIP network NW; a registration control information table 13 (hereinafter, referred to as a control information table 13) for storing a various kinds of information which is necessary for registration processing; a distribution interval computing unit 14 (hereinafter, referred to as a computing unit 14) which computes intervals to register the plurality of SIPURIs; a call controlling unit 15; and a system setting management database 16 (hereinafter, referred to as a management database 16).

Among of them, the call controlling unit 15 has a control function of immediately executing the registration processing of all the SIPURIs into the server SV in accordance with the outgoing call operations from the SIP terminals Ti-Tn when the registration of all the SIPURIs in the server SV results in failure in addition to usual control functions such as outgoing call processing with a calling request from each SIP terminal T1-Tn, incoming call processing with incoming calls from the SIP network NW or a public network (not shown); and transfer processing among the SIP terminals T1-Tn.

The exchange apparatus 1 computes distribution intervals from prescribed registration period and the number of SIP-URIs by means of the computing unit 14, and transmits a REGISTER message for registering a plurality of SIPURIs toward the server SV on the SIP network with leaving intervals by the registration controlling unit 12.

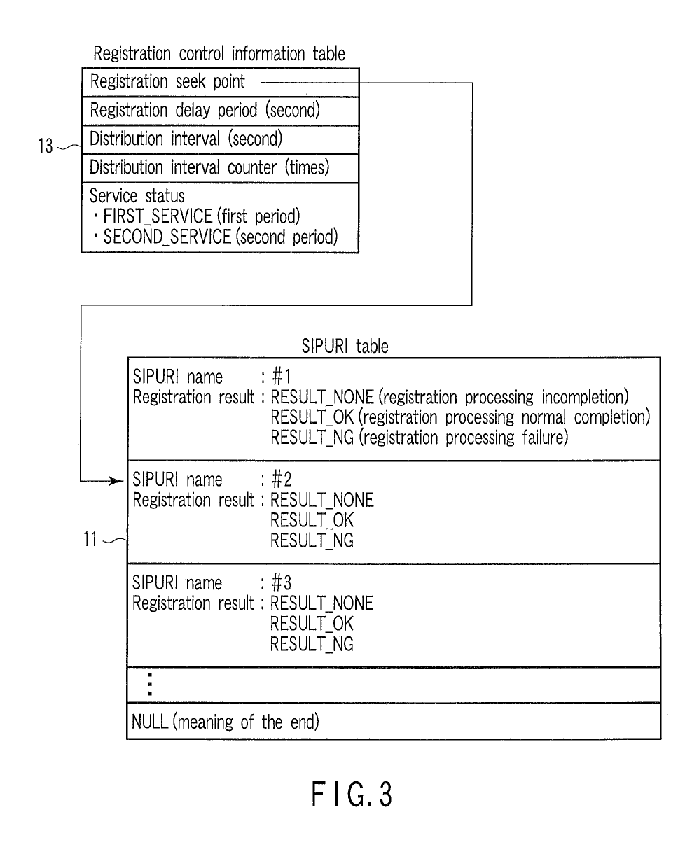

FIG. 3 shows the information table 13 and the SIPURI table 11.

The control information for performing registration processing is stored in the information table 13.

A plurality of SIPURIs to be registered are stored in the SIPURI table 11.

A registration seeking point in the information table 13 is a pointer indicating one SIPURI entry in the SIPURI table 11, the pointer shifts to the next SIPURI after the completion of the registration processing of the corresponding-SIPURI.

The distribution interval is computed by the following expression based on the prescribed registration period and the interval for registering each SIPURI computed from the number of the SIPURIs.

Expression: distribution interval=(registration period−registration allowance time)/2/the number of SIPURIs

A distribution interval counter is one for measuring the distribution intervals and receives timer expiration notification for every one second from the controlling unit 15 to add the distribution intervals. The counter is reset to zero at every time of completion of the registration processing of the SIPURI.

The registration allowance time is a margin which is set in the server SV to perform the next registration for a slightly shorter time period than the registration period so that registration timeout does not occur.

A service sate information is control information owned to divide the registration period into two periods and ‘FIRST_SERVICE’ shows a first period, and ‘SECOND_SERVICE’ shows a second period.

A registration result in the SIPURI table 11 shows the result of the registration processing, ‘RESULT_OK’ shows the normal completion of the registration, ‘RESULT_NG’ shoes the failure of the registration processing, and ‘RESULT_NONE’ shows the fact that the registration processing has not completed yet.

Operations of the system configured as mentioned above will be hereinafter.

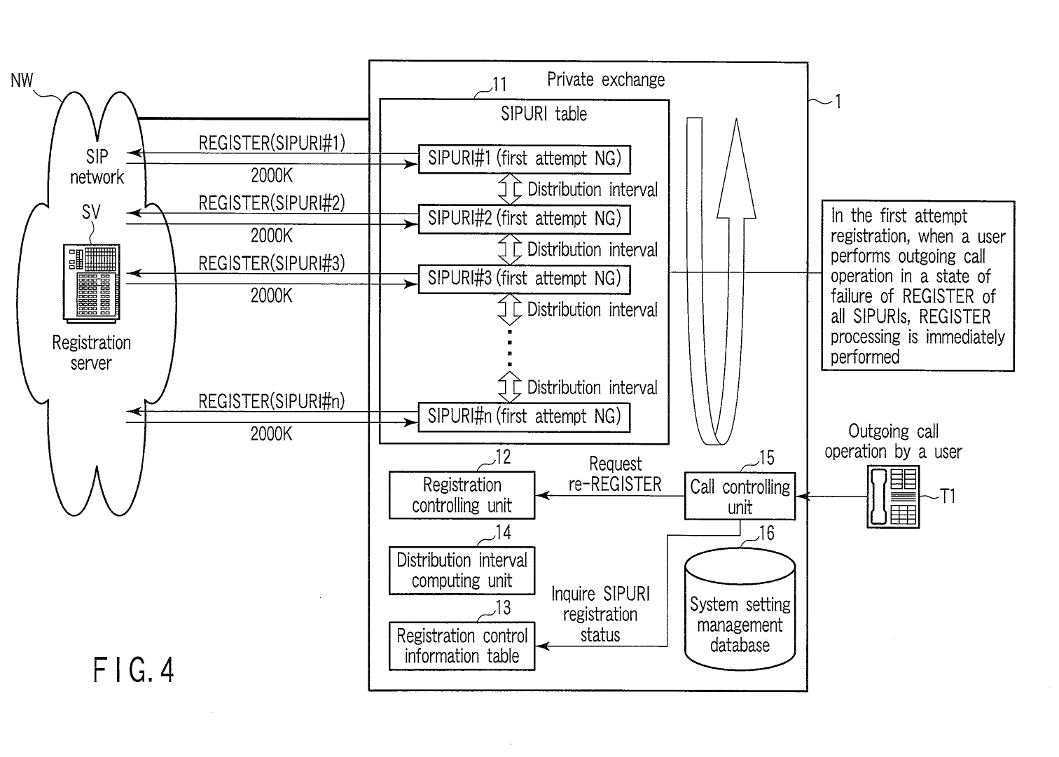

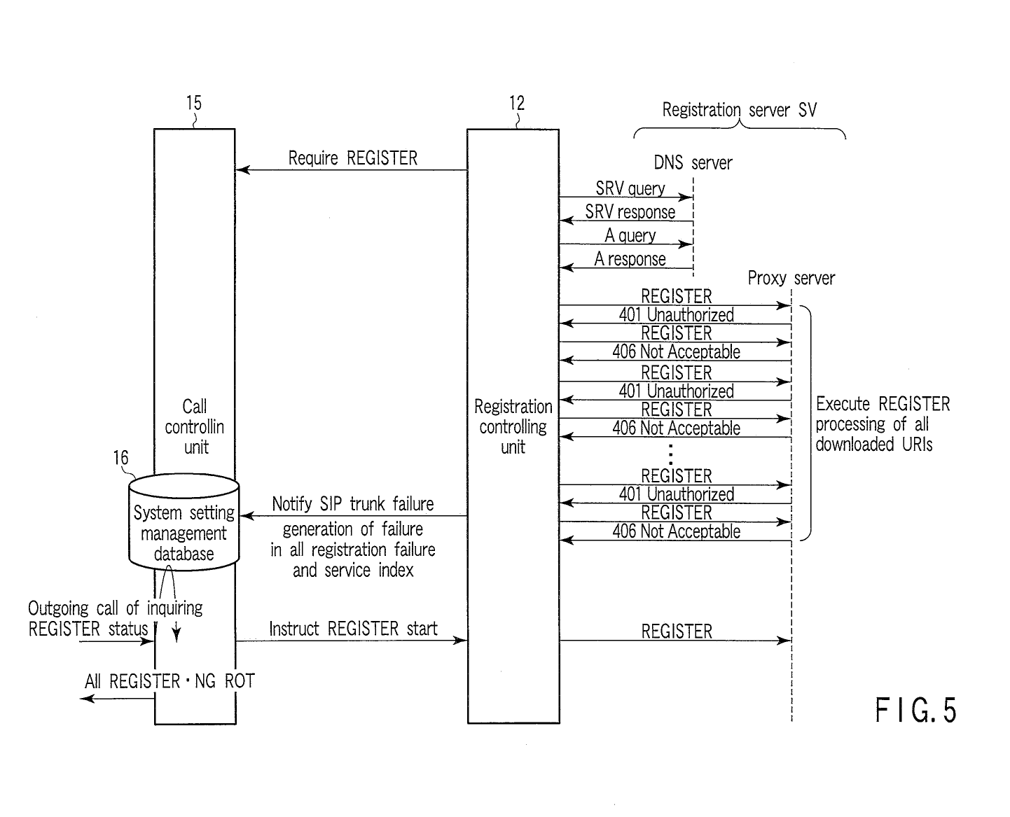

FIG. 4 shows an outline of the ‘REGISTER’ (registration) system by the outgoing call operation during failures of all the ‘SIPURI-REGISTER’, and FIG. 5 shows its processing sequence.

When starting ‘REGISTER’ (registration) processing, the registration controlling unit 12 increments a distribution interval counter, and determines whether or not the SIPURI is now in registration processing from a registration result in the SIPURI table 11.

If the SIPURI is in registration processing (‘RESULT_NONE’), the ‘REGISTER’ processing for the next SIPURI is not performed so as not to overlap the registration processing.

The registration controlling unit 12 confirms the service status, and if the SIPURI is now in ‘FIRST_SERVICE’, performs the following processing as the first period processing.

If the registration processing has already completed (‘RESULT_OK’, or ‘RESULT_NG’), the registration controlling unit 12 increments the registration seeking point by one and starts the registration processing of the next SIPURI. At this moment, the registration controlling unit 12 writes ‘RESULT_NONE’ in this registration result.

When the registration seeking point is incremented by one, if the entry to the SIPURI table 11 is ‘NULL’, the seeking point is determined as the end and the seeking point shifts to the head SIPURI. At this moment, the registration controlling unit 12 changes the service status from ‘FIRST_SERVICE’ to ‘SECOND_SERVICE’.

In ‘SECOND_SERVICE’, after incrementing the distribution interval counter, the registration controlling unit 12 determines whether or not the SIPURI which is pointed by the registration seeking point is now in the registration processing based on the registration result of the SIPURI table 11.

Here, the registration controlling unit 12 increments the registration seeking point until the fact that the registration processing has already completed and the processing has failed in the first period is found, namely until the SIPURI of which the registration result is ‘RESULT_NG’ is found.

When the SIPURI is found, the registration controlling unit 12 starts the registration processing. At this moment, the registration controlling unit 12 writes ‘RESULT_NONE’ as the registration result.

In the aforementioned processing, when the registration seeking point is incremented by one, if the entry in the SIPURI table 11 is ‘NULL’, the registration controlling unit 12 determines that the seeking point is at the end, and shifts the seeking point to the head SIPURI. At this moment, the registration controlling unit 12 changes the service status from the ‘SECOND_SERVICE’ to ‘FIRST_SERVICE’.

After this, when receiving an event that means registration completion such as ‘REGISTER’ response message reception and ‘REGISTER’ transmission timeout notification, the registration controlling unit 12 records the registration result of ‘RESULT_OK’ or ‘RESULT_NG’ in the SIPURI indicated by the registration seeking point. The registration controlling unit 12 clears the distribution interval counter to zero.

In the ‘REGISTER’ processing, when the registration processing for all the SIPURIs #1-#n in the SIPURI table 11 result in failure, the registration controlling unit 12, immediately notifies the fact through an SIP trunk failure notification message to the management database 16.

In this status, it is assumed that the user of the SIP terminal T1 conducts an outgoing call operation to the SIP trunk. The call controlling unit 15 then inquires the ‘REGISTER’ status to the management database 16 to determine whether or not the SIP terminal T1 may make an outgoing call to the SIP trunk. If the ‘REGISTER’ of all the SIPURIs #1-#n is in failure, since the determination results in NG, the call controlling unit 15 notifies the fact that making an outgoing call is impossible through re-order tone (ROT) to the SIP terminal T1 which has required for making the outgoing call.

On the other hand, the call controlling unit 15 instructs the start of ‘REGISTER’ processing through a message to the registration controlling unit 12. When receiving the ‘REGISTER’ start instruction message, the registration controlling unit 12 executes all the ‘REGISTER’ processing by using the known load distribution system.

As mentioned above, in the first embodiment, when the exchange apparatus 1 registers all the SIPURIs #1-#n in the SIPURI table 11 in the server SV, the distribution interval computing unit 14 computes the distribution intervals from the number of SIPURIs registered in the SIPURI table 11 and the registration period, and the registration controlling unit 12 conducts the registration processing of the SIPURIs #1-#n in the SIP terminals T1-Tn at distribution intervals. Meanwhile, when the registration of the SIPURIs #1-#n in the SIP terminals T1-Tn results in failure, the exchange apparatus 1 immediately registers the corresponding-SIPURI #1 existing in the SIPURI table 11 into the server SV without waiting for the next registration period, for example, by an outgoing call operation from the user of the SIP terminal T1 corresponding to the SIPURI #1 as a trigger.

Accordingly, even when the registration of the SIPURI #1 in the server SV SIPURI table 11 results in failure, the disabled period of the use of the SIPURI #1 may be shortened.

### Second Embodiment

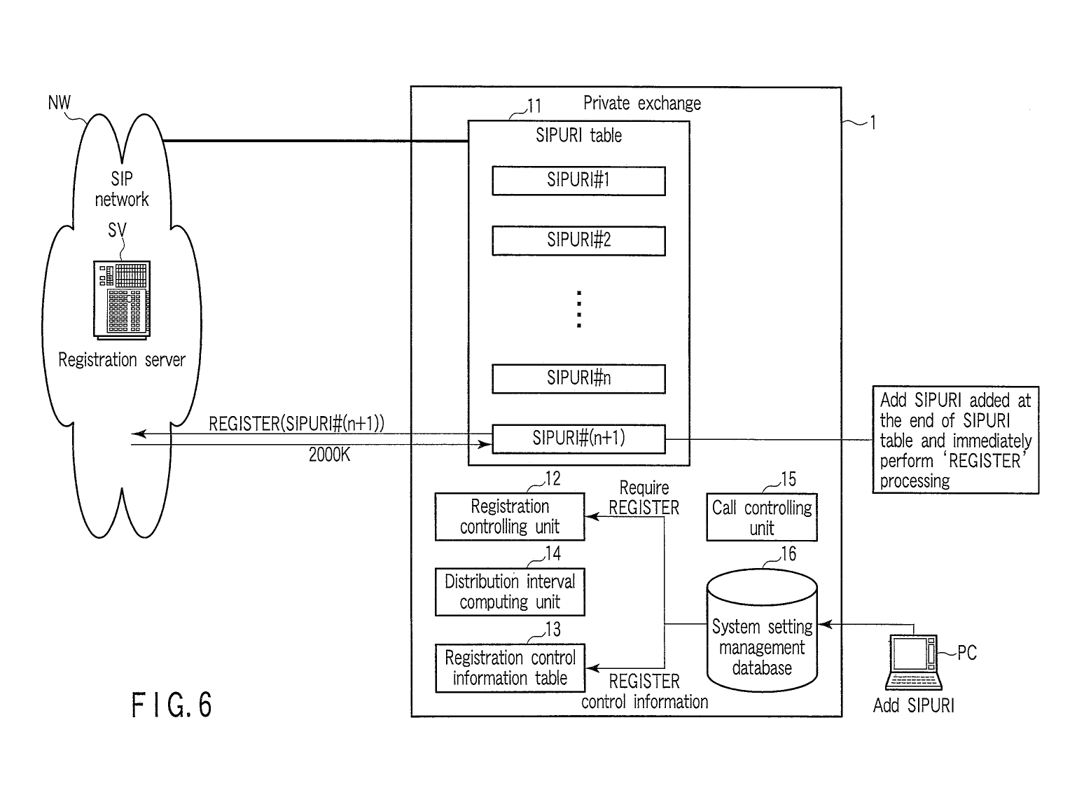

FIG. 6 shows a schematic sequence view illustrating an immediate ‘REGISTER’ processing system at adding a new SIPURI as the second embodiment of the invention.

When SIPURI #(n+1) is newly added to the system by means of a maintenance-exclusive terminal personal computer (PC) etc., its information is registered in the management database 16. The information is immediately downloaded in the control information table 13.

The control information table 13 retrieves whether or not the downloaded information exists on the control information table 13, if the information does not exist, after the information is registered in the control information table 13, a request for ‘REGISTER’ processing of the corresponding-SIPURI #(n+1) in the server SV is issued.

As described above, in the second embodiment, the exchange apparatus 1 immediately registers the corresponding-SIPURI #(n+1) existing in the SIPURI table 11 into the server SV without waiting for the next registration period by setting the additional registration of the SIPURI # (n+1) into the SIPURI table 11 in changing the system, as a trigger,

Accordingly, as similar to the first embodiment, the disabled period of the use of the corresponding-SIPURI #(n+1) may be shortened.

### Other Embodiment

This invention is not limited to the foregoing each embodiment. While the second embodiment has described the time when the SIPURI is added, NON-‘REGISTER’ processing may be performed in deleting the already registered SIPURI. Immediate execution of registration release in deleting enables reducing the non-operation time of the SIPURI.

In each of the embodiments, as long as a communication function defined by the SIP is provided, a terminal using a wireless LAN or a software-phone which is achieved by software on a PC is a possible approach.

Other than this, a configuration and a kind of a system, a configuration and a kind of a private exchange, storage content of a registration control information table, a computing method of registration time intervals and a registration control method of SIPURIs, registration execution timing of SIPURI, etc., may be embodied in various forms without departing from the spirit or scope of the general inventive concept thereof.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A session initiation protocol trunk gateway apparatus to house a plurality of terminals equipped with communication functions mutually specified by session initiation protocol, and to connect a session initiation protocol network, comprising:
a register which registers each connection ID of the plurality of terminals registered in a registration table into a registration server on the session initiation protocol network in accordance with a prescribed registration period;
a connector which connects among the plurality of terminals and the session initiation protocol network, to communicate among the plurality of terminals registered by the register and the session initiation protocol network;
a processor which divides the registration period into a plurality of distribution intervals in response to the number of the connection IDs, and executes registration processing of the next second connection IDs by spacing of the distribution interval from a registration start of a first connection ID among the plurality of connection IDs; and
a controller which executes registration processing of the corresponding-connection IDs into the registration server in preference to the processor based on prescribed conditions in processing by the processor.

2. The apparatus according to claim 1, wherein the controller uses, as determination of the conditions, an outgoing call operation from a user of a session initiation protocol terminal of which the connection ID is failed in registration into the registration server.

3. The apparatus according to claim 1, wherein the controller executes, as determination of the conditions, registration processing of a new connection ID in the registration server in preference to the processor when the new connection ID is additionally registered in the registration table.

4. The apparatus according to claim 1, the controller executes registration release processing to deleted connection ID in preference to the processor when connection ID is deleted from the registration table.
